(19) United States
(12) Patent Application Publication
(10) Pub. No.: US 2007/0012611 A1
(43) Pub. Date: Jan. 18, 2007

(54) Water purification filter assembly for use in a refrigerator and refrigerator including the same

(75) Inventor: Jae-koog An, Gwanglu city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/340,687

(22) Filed: Jan. 27, 2006

(30) Foreign Application Priority Data
Jul. 16, 2005 (KR) 10-2005-64584

(51) Int. Cl. B01D 35/14

(52) U.S. Cl. 210/232; 210/248

(57) ABSTRACT

A water purification filter assembly used in a refrigerator includes a filter head provided with an inflow conduit connected to a predetermined water source and an outflow conduit discharging purified water; a water purification filter detachably coupled with the filter head; a case housing the filter head and the water purification filter in such a way that the water purification filter is coupled with and disconnected from the filter head in a horizontal direction; and a water pooling member provided on the case to prevent water, which leaks from the filter head while the water purification filter is coupled with or disconnected from the filter head, from flowing down to an outside of the case. Thus, provided is a water purification filter assembly, which is capable of making it unnecessary to secure an extra space around a case for a replacement of a water purification filter and preventing water leaking from a filter head during the replacement of the water purification filter from flowing down to a storage compartment, and a refrigerator including the same.

### CROSS-REFERENCE TO RELATED APPLICATIONS

This application claims priority from Korean Patent Application No. 2005-0064584, filed on Jul. 16, 2005, in the Korean Intellectual Property Office, the disclosure of which is incorporated herein by reference.

### BACKGROUND OF THE INVENTION

1. Field of the Invention

The present invention relates to a water purification filter assembly and a refrigerator including the same.

2. Description of the Related Art

In a conventional refrigerator, to use purified water, a user stores water purified by a separate water purification apparatus in a refrigerating compartment or freezes it in a freezing compartment to make ice.

However, due to both a multifunction and enlargement trend of a refrigerator in recent times, various functions are being combined into a refrigerator. Such a refrigerator is now commercially available in the market, which has a water purification filter assembly and supplies the purified water produced by the water purification filter assembly to an ice maker to make ice or to a dispenser to use the purified water. As disclosed in Korean Patent Publication No. 2001-0009451 and International Patent Publication No. WO 03/008883A1, a variety of water purification filter assemblies installed in a refrigerator are publicly known already.

Among them, a generally used water purification filter assembly will be described with reference to FIG. 6. The water purification filter assembly includes a water purification filter 131 purifying water, a pair of cases 151, 153 installed in an inner wall of a storage compartment 110 to house the water purification filter 131 and a filter head 140 coupled with the water purification filter 131 and connected to an external water source, a dispenser and the like.

In such a conventional water purification filter assembly, when replacing the water purification filter 131, it is usual that after the lower case 153 is pivoted to be opened in a direction indicated by an arrow from the upper case 151 fixed on an upper portion of the storage compartment, the water purification filter 131 in the cases 151,153 is rotated to be removed therefrom.

However, there is a drawback in this case; an extra space for replacement is required around the cases 151, 153 to replace the water purification filter 31. That is, as shown in FIG. 6, since the lower case 153 should be pivoted downwards, if there are stored goods put under the lower case 153, they should be removed before the replacement of the water purification filter 131. Therefore, the filter replacement process becomes troublesome. In a case of not putting the stored goods under the lower case 153 precautionarily, a space efficiency becomes degraded.

Further, there has been a problem in the water purification filter assembly described above; since the lower case 153 is sloping downwards toward the inside of the refrigerator 1, water leaking from a filter head (not shown) during the replacement of the water purification filter 131 flows down to the storage compartment 110 to spoil an appearance, and a user needs to wipe it whenever the filter is replaced.

### SUMMARY OF THE INVENTION

Additional aspects and/or advantages of the invention will be set forth in part in the description which follows and, in part, will be apparent from the description, or may be learned by practice of the invention.

Accordingly, it is an aspect of the present invention to provide a water purification filter assembly, which is capable of making it unnecessary to secure an extra space around a case for a replacement of a water purification filter and preventing water leaking from a filter head during the replacement of the water purification filter from flowing down to a storage compartment, and a refrigerator including the same.

The foregoing and/or other aspects of the present invention can be achieved by providing a water purification filter assembly used in a refrigerator, including: a filter head provided with an inflow conduit connected to a predetermined water source and an outflow conduit discharging purified water; a water purification filter detachably coupled with the filter head; a case housing the filter head and the water purification filter in such a way that the water purification filter is coupled with and disconnected from the filter head in a horizontal direction; and a water pooling member provided on the case to prevent water, which leaks from the filter head while the water purification filter is coupled with or disconnected from the filter head, from flowing down to an outside of the case.

According to an aspect of the present invention, the case is of a hollow cylinder and provided with a filter inserting part whose one portion is opened in such a way that the water purification filter passes through the one portion.

According to an aspect of the present invention, the water purification filter assembly used in a refrigerator further includes a case door selectively opening and closing the filter inserting part.

According to an aspect of the present invention, one side of the case door is hinged to the case to rotatably open and close the filter inserting part.

According to an aspect of the present invention, the water purification filter assembly used in a refrigerator further includes a locking member retaining the case door in a closed position.

According to an aspect of the present invention, the locking member is provided with a fitting protrusion protrudingly formed on one of the case door and the filter inserting part and a fitting protrusion receptacle part provided on the other one of the case door and the filter inserting part to receive the fitting protrusion.

According to an aspect of the present invention, the filter head is connected with the inflow conduit and the outflow conduit, and has a coupling bracket coupled with the water purification filter and a bracket supporting part which supports the coupling bracket and is mounted on a storage compartment of the refrigerator, and the case is further provided with a combining part for combining with the bracket supporting part.

According to an aspect of the present invention, the water pooling member is provided with a stepped portion which is formed toward from one end portion of the case to the other end portion of the case and has a predetermined height with respect to the case.

According to an aspect of the present invention, the water pooling member is provided with a water pooling protrusion protruded from a bottom surface of the case.

According to an aspect of the present invention, the water purification filter assembly used in a refrigerator further includes a water absorbing member which is provided on the case to absorb a water collected by the water pooling member.

The foregoing and/or other aspects of the present invention can be achieved by providing a water purification filter assembly used in a refrigerator, which is installed in the refrigerator with at least one storage compartment to purify water introduced thereto from a predetermined water source and supply the purified water, the water purification filter assembly including: a filter head which is installed in the storage compartment, and which is provided with an inflow conduit connected to the predetermined water source and an outflow conduit discharging the purified water; a water purification filter detachably coupled with the filter head; a case which houses the filter head and the water purification filter in such a way that the water purification filter is coupled with and disconnected from the filter head in a horizontal direction, and which is provided with a filter inserting part whose one portion is opened in such a way that the water purification filter passes through the one portion; and a water pooling member provided on the case to prevent water, which leaks from the filter head while the water purification filter is combined with or detached from the filter head, from flowing down to an outside of the case.

According to an aspect of the present invention, the water purification filter assembly used in a refrigerator further includes a case door whose one side is hinged to the case to rotatably open and close the filter inserting part.

According to an aspect of the present invention, the water purification filter assembly used in a refrigerator further includes a locking member retaining the case door in a closed position.

According to an aspect of the present invention, the water purification filter assembly used in a refrigerator further includes a water absorbing member which is provided on the case to absorb water collected by the water pooling member on a bottom surface of the case.

The foregoing and/or other aspects of the present invention can be achieved by providing a refrigerator, including: a storage compartment; a filter head which is installed in the storage compartment, and which is provided with an inflow conduit connected to a predetermined water source and an outflow conduit discharging purified water; a water purification filter detachably coupled with the filter head; a case which houses the filter head and the water purification filter in such a way that the water purification filter is coupled with and disconnected from the filter head in a horizontal direction, and which is provided with a filter inserting part whose one portion is opened in such a way that the water purification filter passes through the one portion; and a water pooling member provided on the case to prevent water, which leaks from the filter head while the water purification filter is combined with or detached from the filter head, from flowing down to an outside of the case.

According to an aspect of the present invention, the refrigerator further includes a case door whose one side is hinged to the case to rotatably open and close the filter inserting part.

According to an aspect of the present invention, the refrigerator further includes a locking member retaining the case door in a closed position.

According to an aspect of the present invention, the refrigerator further includes a water absorbing member which is provided on the case to absorb a water collected by the water pooling member on a bottom surface of the case.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a front view of a refrigerator in accordance with the present invention;

FIG. 2 shows an exploded perspective view of a water purification filter assembly for use in a refrigerator in accordance with a first embodiment of the present invention;

FIG. 3 sets forth a perspective view of a case of the water purification filter assembly for use in a refrigerator in accordance with a second embodiment of the present invention;

FIG. 4 offers an exploded view of the water purification filter assembly for use in a refrigerator before a water purification filter is inserted;

FIG. 5 depicts a combined view of the water purification filter assembly for use in a refrigerator shown in FIG. 4 after the water purification filter is inserted; and

FIG. 6 illustrates a magnified view corresponding to section A shown in FIG. 1 when a water purification filter is replaced in a conventional water purification filter assembly for use in a refrigerator.

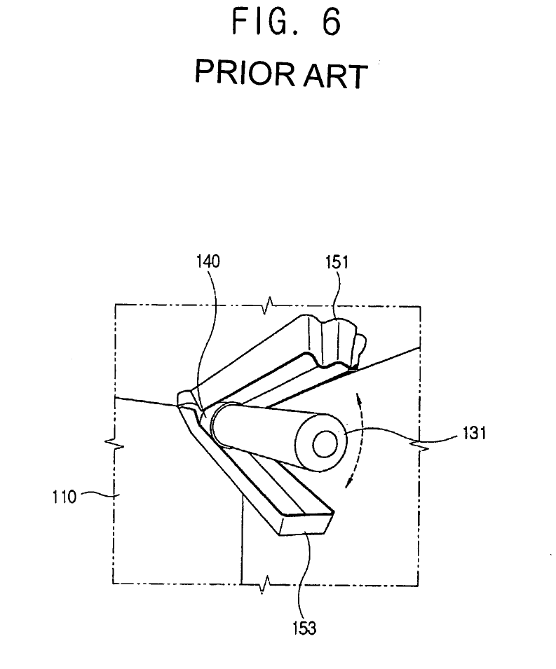

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures. Further, it should be noted that a side by side type refrigerator is used as an example to describe the embodiments of the present invention but the present invention is not limited thereto.

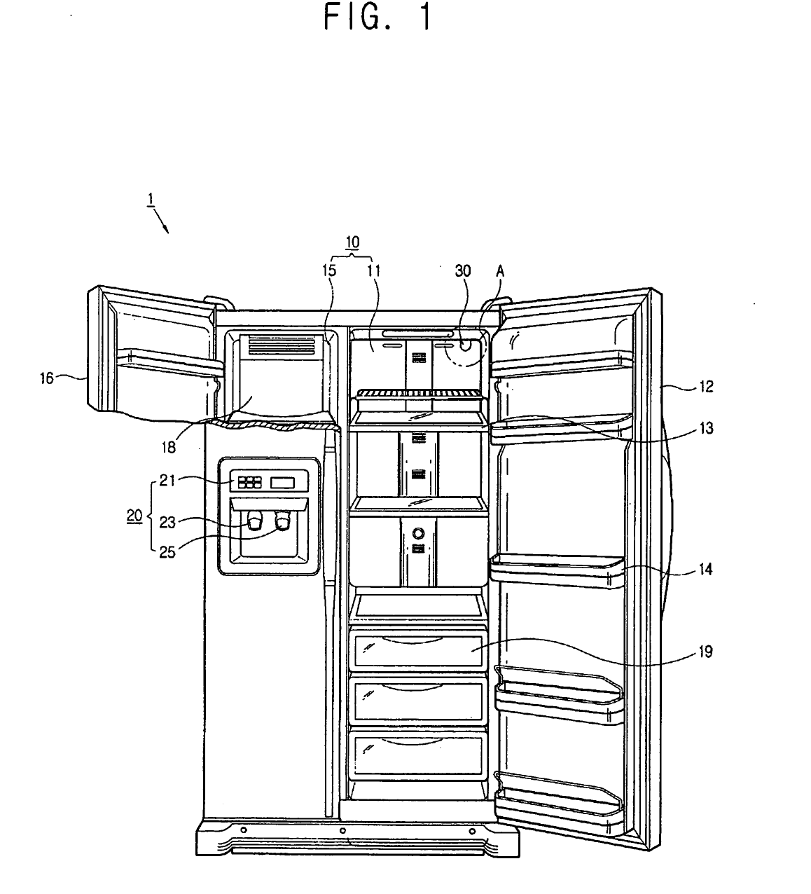

FIG. 1 is a front view of a refrigerator 1 equipped with a water purification filter assembly 30 for use in a refrigerator in accordance with the present invention. Referring to the drawing, the refrigerator 1 includes a storage compartment 10 divided into a refrigerating compartment 11 and a freezing compartment 15 by a center partition wall, a pair of doors 12, 16 for selectively opening and closing the storage compartment 10, respectively, and the water purification filter assembly 30 for use in a refrigerator. The refrigerator 1 may further include an ice maker 18 which makes an ice using purified water supplied from the water purification filter assembly 30 used in a refrigerator, and a dispenser part 20 receiving the purified water.

The refrigerating compartment 11 is provided with a plurality of shelves 13 dividing its inner space into plural storage spaces, and drawer-type storage cabinets 19 disposed in its lower portion to accommodate foods such as fruits, vegetables and the like. Meanwhile, on an inner surface of the refrigerating compartment door 12 for selectively opening and closing the refrigerating compartment 11, a plurality of storage shelves 14 are provided to accommodate bottles and the like.

The freezing compartment 15 is provided with the ice maker 18 which makes an ice using the purified water supplied from the water purification filter assembly 30 for use in a refrigerator.

The freezing compartment door 16, which selectively opens and closes the freezing compartment 15, is provided with the dispenser part 20 on its outside that has a water dispenser 25 for using the purified water, an ice dispenser 23 for using the ice made in the ice maker 18 and a control panel 21 on which a function key for selecting the kind of ice and other function keys are provided.

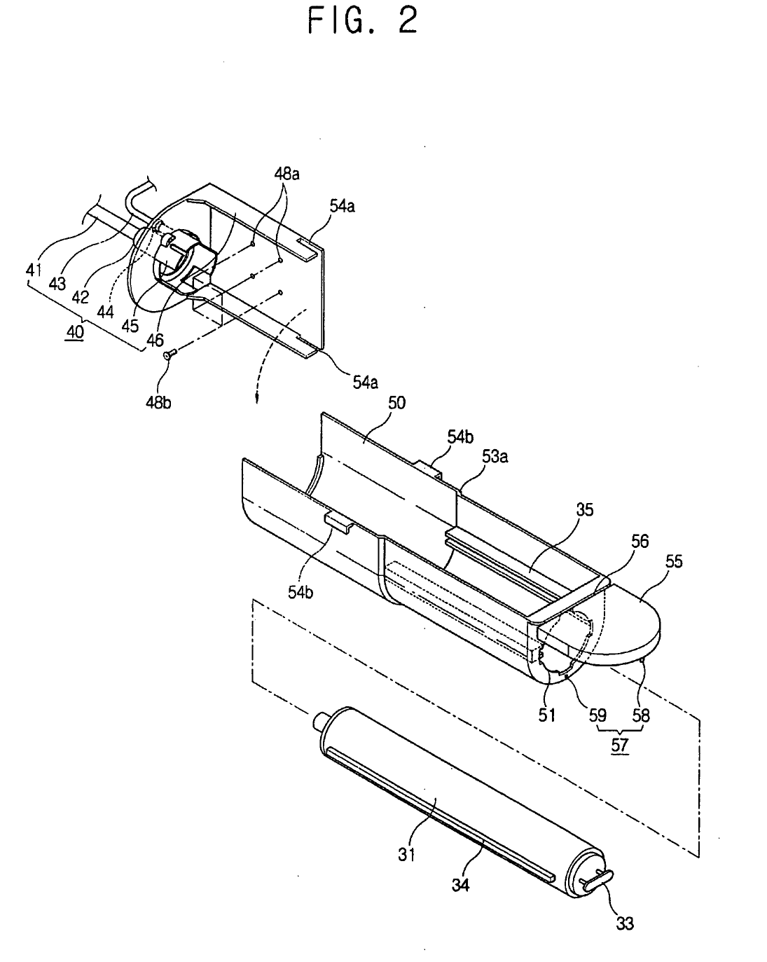

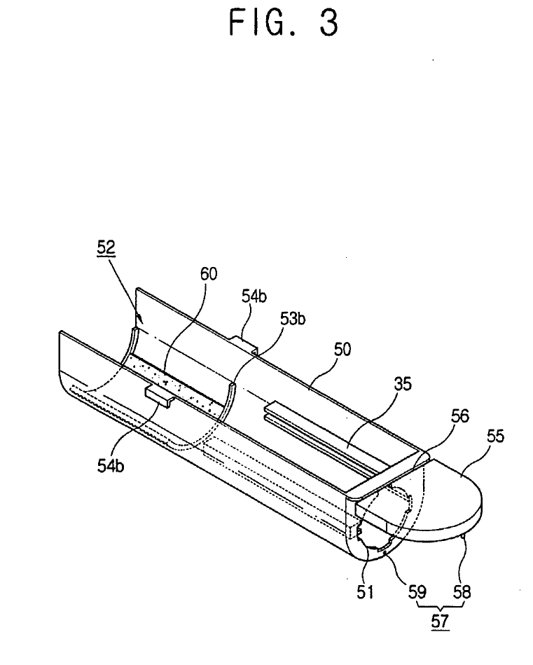

FIG. 2 is an exploded perspective view illustrating structure of the water purification filter assembly 30 for use in a refrigerator in accordance with the present invention. Referring to the drawing, the water purification filter assembly 30 for use in a refrigerator includes a water purification filter 31, a filter head 40 detachably coupled with the water purification filter 31 and provided with an inflow conduit 41 supplying water to the water purification filter 31 and an outflow conduit 43 discharging the purified water, and a case 50 housing the filter head 40 and the water purification filter 31 in such a way that the filter head 40 and the water purification filter 31 are coupled with each other and disconnected from each other in a length direction of the water purification filter 31. Herein, the water purification filter assembly 30 for use in a refrigerator may further include a case door 55 selectively opening and closing an end opening of the case 50 and a water pooling member 53a or 53b (see FIG. 3) provided in the case 50.

The water purification filter 31 is supplied with water from an external water source (not shown) through the inflow conduit 41 of the filter head 40 and purifies the water. Then, the water purification filter 31 supplies the purified water to the dispenser part 20 (see FIG. 1) and the ice maker 18 through the outflow conduit 43. There is no limit to the kind of the water purification filter 31, and it can be constituted by any publicly disclosed ones. On one end portion of the water purification filter 31, a handle 33 is provided to facilitate the coupling and disconnecting of the water purification filter 31 with and from the filter head 40.

The water purification filter 31 can be coupled with the filter head 40 in a variety of methods including. For example, in a push method, the coupling is accomplished therebetween by bringing the other end of the water purification filter 31 into contact with the filter head 40 and then by pushing the handle 33, and the disconnection therebetween is made by pushing the handle 33 again in the same direction. Also, in a rotating method, the coupling is accomplished therebetween by bringing the other end of the water purification filter 31 into contact with the filter head 40 and then by rotating the water purification filter 31 clockwise or counterclockwise.

The water purification filter 31 may be provided with a pair of protrusion parts 34 on its circumferential surface to indicate a coupling direction thereof with the filter head 40. The case 50 may be provided with a pair of guides 35 on its inner circumferential surface to receive the protrusion parts 34 and guide the water purification filter 31 to the filter head 40.

The filter head 40 has a coupling bracket 45 to be coupled with the water purification filter 31, a bracket supporting part 46 to be combined with the case 50 which supports the coupling bracket 45, and an inflow conduit connecting part 42 and an outflow conduit connecting part 44 which are provided on the bracket supporting part 46.

The bracket supporting part 46 has a fastening part 48 for coupling to an inner housing of the refrigerating compartment 11 (see FIG. 1) and a combining part 54a, 54b for coupling to the case 50. The fastening part 48, for example, may be provided with a plurality of screw fixing holes 48a formed in the bracket supporting part 46, and screws 48b screwed into the screw fixing holes 48a. Meanwhile, the combining part 54a, 54b may be provided with hanging hooks 54b provided on the case 50 and receptacle grooves 54a formed in the bracket supporting part 46 to receive the hanging hooks 54b.

The inflow conduit 41 is interposed between the external water source and the inflow conduit connecting part 42 to supply water to the water purification filter 31, while the outflow conduit 43 is interposed between the outflow conduit connecting part 44 and a supply valve (not shown) dividing the purified water to supply it to the dispenser part 20 and the ice maker 18.

The case 50 is configured to house the filter head 40 and the water purification filter 31 in such a way that the water purification filter 31 and the filter head 40 are coupled with each other and disconnected from each other in the length direction of the water purification filter 31, i.e., a horizontal direction. The case 50 can take a variety of shapes as long as a lengthwise movement of the water purification filter 31 is not affected. For example, as shown in FIG. 2, it has a shape of a hollow body with both ends and upper portion opened, whose cross section is approximately semicircular or rectangular. Further, the case 50 can have a shape of a hollow cylinder with both ends opened.

A filter inserting part 51 through which the water purification filter 31 is loaded into or unloaded from the inside of the case 50 is provided in one end portion of the case 50. The filter inserting part 51 can take a variety of shapes according to sizes and cross sectional shapes of the water purification filter 31.

The case 50 may be provided with the case door 55 closing the filter inserting part 51 so that the water purification filter 31 may not be shown to the outside. The case door 55 can improve a front exterior appearance of the water purification filter assembly 30 for use in a refrigerator by preventing the water purification filter 31 from being seen by a user. Further, the case 50 may be configured to house a portion of the water purification filter 31 exposing the rest portion thereof to the outside.

The case door 55 can be provided at the one end portion of the case 50 so as to selectively open and close the filter inserting part 51. The case door 55 can selectively open and close the filter inserting part 51 in a variety of methods. For example, as shown in FIG. 2, one side of the case door 55 is hinged to the case 50 to rotate upwards and downwards, opening and closing the filter inserting part 51. In this case, a film hinge 56 may be used, but there is no limit to the kind of hinge connection.

A locking member 57 is provided on at least one of the case 50 and the case door 55 in such a way that the case door 55 is retained to close the filter inserting part 51. The locking member 57, for example, can be provided with a fitting protrusion 58 protrudingly formed on one of the case door 55 and the filter inserting part 51 and a fitting protrusion receptacle part 59 provided on the other one of the case door 55 and the filter inserting part 51 to receive the fitting protrusion 58. In this case, it is prevented that the case door 55 is opened and closed unnecessarily, and the user can feel engagement feeling, so that the user's convenience can be improved.

The water pooling member 53a, 53b is provided on the case 50 to prevent water, which leaks from the filter head 40 during the replacement of the water purification filter 31, from flowing down to the storage compartment 10 through the filter inserting part 51. The water pooling member 53a, 53b, for example, is provided with the stepped portion 53a formed on a bottom surface of the case 50 toward the filter inserting part 51, having a predetermined height as shown in FIG. 2. In this case, the bottom surface of the case 50 is formed in such a way that a portion thereof near the filter head 40 is lower than a portion thereof near the filter inserting part 51. Therefore, the water leaking from the filter head 40 during the replacement of the water purification filter 31 stays on the bottom surface of the case 50 not to flow down to the storage compartment 10. A height of the stepped portion 53a can be determined according to an amount of the water generally leaking during the replacement of the water purification filter 31. Meanwhile, the water staying on the bottom surface of the case 50 naturally evaporates in the storage compartment 10 to disappear over time. Further, as shown in FIG. 3, the water pooling member can be provided with the water pooling protrusion 53b disposed between the a filter head receptacle part 52 and the filter inserting part 51.

Further, the case 50 can be further provided with a water absorbing member 60 which absorbs the water collected by the water pooling member 53b. Herein, it is needless to say that the water absorbing member 60 can be applied to the case 50 in accordance with the first embodiment shown in FIG. 2.

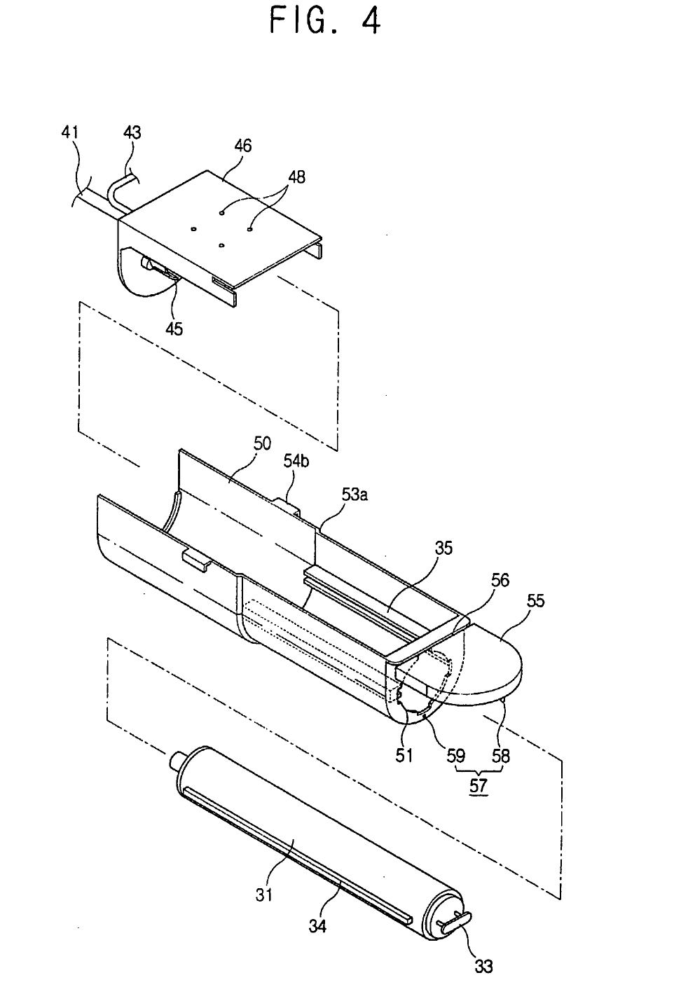

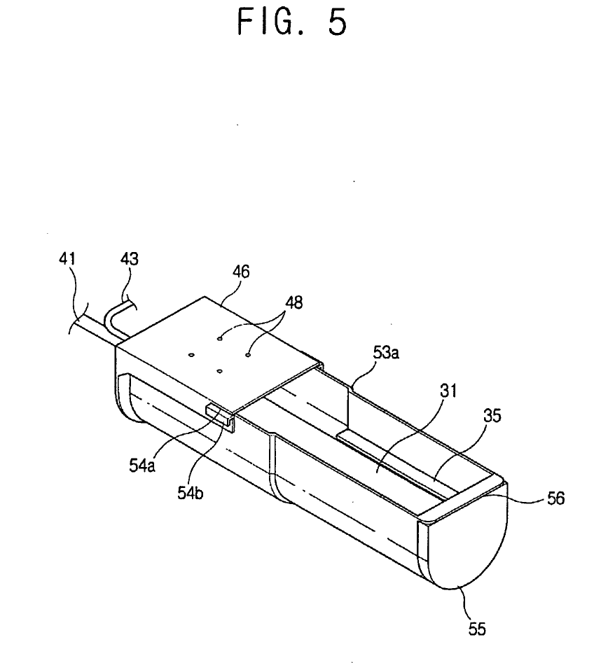

An installing of the water purification filter assembly 30 for use in a refrigerator with the configuration described above and a replacement process of the water purification filter 31 will be described with reference to FIGS. 4 and 5. FIG. 4 is an exploded perspective view of the water purification filter assembly 30 for use in a refrigerator before the water purification filter 31 is inserted, and FIG. 5 is a perspective view of the case 50 after the water purification filter 31 is inserted.

It should be informed that although, in an actual case, the water purification filter assembly 30 for use in a refrigerator is coupled to the inner housing of the storage compartment 10 of the refrigerator 1 (see a section A shown in FIG. 1), only the water purification filter assembly 30 for use in a refrigerator is shown in FIGS. 4 and 5 for the sake of convenience of explanation.

First, the filter head 40 is mounted on the inner housing of the refrigerating compartment 11 via the fastening part 48 provided in the bracket supporting part 46. Then, the case 50 is pushed to the inside of the refrigerating compartment 11 at the same height as the filter head 40, so that the receptacle grooves 54a provided on the case 50 are engaged with the hanging hooks 54b of the bracket supporting part 46. The filter head 40 and the case 50 are installed in the refrigerating compartment 11 through the aforementioned processes.

Next, the replacement process of the water purification filter 31 will now be described as follows. The case 50 and the filter head 40 are installed in the refrigerating compartment 11, and the inflow conduit 41 connected to the external water source to supply water to the water purification filter 31 and the outflow conduit 43 guiding the water purified in the water purification filter 31 to the supply valve (not shown) are connected to the filter head 40.

In the one end portion of the case 50, the filter inserting part 51 through which the water purification filter 31 is loaded into and unloaded from the inside of the case 50 is provided. Therefore, the user rotates the case door 55 upwards to open the filter inserting part 51, and then inserts the water purification filter 31 into the filter inserting part 51 to couple it with the filter head 40. At this time, the water purification filter 31 and the filter head 40 can be combined with each other in a variety of methods. For example, the user pushes the handle 33 to insert the water purification filter 31 continuously until the combining therebetween is accomplished, or insert the water purification filter 31 to a predetermined depth and then rotates it to accomplish the combining therebetween. When the water purification filter 31 and the filter head 40 are combined with each other, the water purification filter 31 is housed in the case 50. So the case door 55 is rotated back to close the filter inserting part 51 (see FIG. 5).

As described above, in accordance with the water purification filter assembly for use in a refrigerator in accordance with the present invention and the refrigerator including the same, since the water purification filter is moved in a length direction to be coupled with and disconnected from the filter head, it is unnecessary for the case to pivot in a vertical direction or in a left-right direction, so that it becomes also unnecessary to secure an extra space around the case. Accordingly, space efficiency is improved.

Further, since the water leaking from the filter head during the replacement of the water purification filter stays on the case and naturally evaporates, water leaking from the filter head and flowing down to the storage compartment is prevented, so that there is no need to wipe the water whenever it flows down to the storage compartment. Accordingly, the users' convenience is enhanced.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A water purification filter assembly used in a refrigerator, comprising:
a filter head provided with an inflow conduit connected to a predetermined water source and an outflow conduit discharging purified water;
a water purification filter detachably coupled with the filter head;
a case housing the filter head and the water purification filter in such a way that the water purification filter is coupled with and disconnected from the filter head in a horizontal direction; and
a water pooling member provided on the case to prevent water, which leaks from the filter head while the water purification filter is coupled with or disconnected from the filter head, from flowing down to an outside of the case.

2. The water purification filter assembly used in a refrigerator according to claim 1, wherein the case is of a hollow cylinder and provided with a filter inserting part whose one portion is opened in such a way that the water purification filter passes through the one portion.

3. The water purification filter assembly used in a refrigerator according to claim 2, further comprising a case door selectively opening and closing the filter inserting part.

4. The water purification filter assembly used in a refrigerator according to claim 3, wherein one side of the case door is hinged to the case to rotatably open and close the filter inserting part.

5. The water purification filter assembly used in a refrigerator according to claim 4, further comprising a locking member retaining the case door in a closed position.

6. The water purification filter assembly used in a refrigerator according to claim 5, wherein the locking member is provided with a fitting protrusion protrudingly formed on one of the case door and the filter inserting part and a fitting protrusion receptacle part provided on the other one of the case door and the filter inserting part to receive the fitting protrusion.

7. The water purification filter assembly used in a refrigerator according to claim 3, further comprising a locking member retaining the case door in a closed position.

8. The water purification filter assembly used in a refrigerator according to claim 7, wherein the locking member is provided with a fitting protrusion protrudingly formed on one of the case door and the filter inserting part and a fitting protrusion receptacle part provided on the other one of the case door and the filter inserting part to receive the fitting protrusion.

9. The water purification filter assembly used in a refrigerator according to claim 1, wherein the filter head is connected with the inflow conduit and the outflow conduit, and has a coupling bracket coupled with the water purification filter and a bracket supporting part which supports the coupling bracket and is mounted on a storage compartment of the refrigerator, and
wherein the case is further provided with a combining part for combining with the bracket supporting part.

10. The water purification filter assembly used in a refrigerator according to claim 1, wherein the water pooling member is provided with a stepped portion which is formed toward from one end portion of the case to the other end portion of the case and has a predetermined height with respect to the case.

11. The water purification filter assembly used in a refrigerator according to claim 1, wherein the water pooling member is provided with a water pooling protrusion protruded from a bottom surface of the case.

12. The water purification filter assembly used in a refrigerator according to claim 1, further comprising a water absorbing member which is provided on the case to absorb a water collected by the water pooling member.

13. A water purification filter assembly used in a refrigerator, which is installed in the refrigerator with at least one storage compartment to purify water introduced thereto from a predetermined water source and supply the purified water, the water purification filter assembly comprising:
a filter head which is installed in the storage compartment, and which is provided with an inflow conduit connected to the predetermined water source and an outflow conduit discharging the purified water;
a water purification filter detachably coupled with the filter head;
a case which houses the filter head and the water purification filter in such a way that the water purification filter is coupled with and disconnected from the filter head in a horizontal direction, and which is provided with a filter inserting part whose one portion is opened in such a way that the water purification filter passes through the one portion; and
a water pooling member provided on the case to prevent water, which leaks from the filter head while the water purification filter is combined with or detached from the filter head, from flowing down to an outside of the case.

14. The water purification filter assembly used in a refrigerator according to claim 13, further comprising a case door whose one side is hinged to the case to rotatably open and close the filter inserting part.

15. The water purification filter assembly used in a refrigerator according to claim 14, further comprising a locking member retaining the case door in a closed position.

16. The water purification filter assembly used in a refrigerator according to claim 13, further comprising a water absorbing member which is provided on the case to absorb water collected by the water pooling member on a bottom surface of the case.

17. A refrigerator, comprising:
a storage compartment;
a filter head which is installed in the storage compartment, and which is provided with an inflow conduit connected to a predetermined water source and an outflow conduit discharging purified water;
a water purification filter detachably coupled with the filter head;
a case which houses the filter head and the water purification filter in such a way that the water purification filter is coupled with and disconnected from the filter head in a horizontal direction, and which is provided with a filter inserting part whose one portion is opened in such a way that the water purification filter passes through the one portion; and
a water pooling member provided on the case to prevent water, which leaks from the filter head while the water purification filter is combined with or detached from the filter head, from flowing down to an outside of the case.

18. The refrigerator according to claim 17, further comprising a case door whose one side is hinged to the case to rotatably open and close the filter inserting part.

19. The refrigerator according to claim 18, further comprising a locking member retaining the case door in a closed position.

20. The refrigerator according to claim 17, further comprising a water absorbing member which is provided on the case to absorb a water collected by the water pooling member on a bottom surface of the case.

21. The refrigerator according to claim 18, wherein the case door is hinged to the case with a film hinge.
